(19) United States
(12) Patent Application Publication
(10) Pub. No.: US 2016/0027410 A1
(43) Pub. Date: Jan. 28, 2016

(54) CONTENT UPDATE FROM A DISPLAY DRIVER IN MOBILE APPLICATIONS

(71) Applicant: QUALCOMM MEMS Technologies, Inc., San Diego, CA (US)

(72) Inventors: Hamid Tavakoli, Palo Alto, CA (US); William Cummings, Mountain View, CA (US); Shen-Ge Wang, Milpitas, CA (US); Wilhelmus Johannes Robertus Van Lier, San Diego, CA (US)

(21) Appl. No.: 14/341,147

(22) Filed: Jul. 25, 2014

(51) Int. Cl. G09G 5/18; G06T 9/00

(52) U.S. Cl. CPC G09G 5/18; G06T 9/00

(57) ABSTRACT

Various display device implementations disclosed herein include display drivers with enhanced capabilities. In some implementations a display driver may be capable of updating a display while a central processing unit (CPU) is switched off or operating in a sleep mode. Some such display drivers may include a display driver clock and a display driver memory. The display driver may be capable of receiving image data from the CPU, including image data for display updates, and storing received image data in the display driver memory. The display driver may be capable of updating the display with stored image data at times indicated by the display driver clock. Some display drivers may include a graphics processing unit capable of generating image data for updates of the display. In some such implementations, the graphics processing unit may be capable of dithering image data.

### TECHNICAL FIELD

This disclosure relates to electromechanical systems and devices, and more particularly to electromechanical systems for implementing reflective display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interferometric absorption. In some implementations, an IMOD display element may include a pair of conductive plates, one of which has a high reflectance and one is partially absorptive. The pair of conductive plates are capable of relative motion upon application of an appropriate electrical signal. For example, one plate may include a stationary layer deposited over, on or supported by a substrate and the other plate may include a partial absorptive membrane separated from the stationary layer by an air gap. The position of one plate in relation to another can change the spectrum of the reflected light from the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device. The display device may include a display and a control system. The control system may include a central processing unit and a display driver. The display driver may include a display driver clock and a display driver memory.

The display driver may be capable of receiving image data from the central processing unit. The image data may include image data for display updates. The display driver may be capable of storing received image data in the display driver memory and updating the display with stored image data at times indicated by the display driver clock. In some implementations, the image data may include data for updates of a clock image.

According to some implementations, the central processing unit may be capable of compressing image data. The display driver may be capable of receiving compressed image data from the central processing unit and storing the compressed image data in the display driver memory. The display driver may be capable of retrieving a portion of the compressed image data, e.g., at a time indicated by the display driver clock. The display driver may be capable of decompressing the portion of the compressed image data to produce a decompressed portion of image data and of updating the display with the decompressed portion of image data. According to some implementations, the display driver may be capable of performing the receiving, storing and updating while the central processing unit is switched off or operating in a sleep mode.

In some examples, the display driver may be capable of converting the received image data from a first image data type to a second image data type suitable for controlling the display. The display driver may be capable of storing the second image data type in the display driver memory.

According to some implementations, the display driver may include an image update engine capable of receiving clock signals from the display driver clock and of selecting stored image data for updating the display based, at least in part, on the clock signals. The image update engine may be capable of causing the selected image data to be provided by the display driver memory to the display. In some examples, the display driver may include a graphics processing unit capable of generating image data for updates of the display.

In some examples, the control system may include a processor and an image source module capable of sending image source module image data to the processor. The image source module may include a receiver, a transceiver and/or a transmitter. In some examples, the control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The display device may include an input device capable of receiving input data and of communicating the input data to the control system.

According to some implementations, the display may include interferometric modulator (IMOD) pixels. However, in other implementations the display may include other types of pixels.

Some or all of the methods described herein may be performed by one or more devices according to instructions (e.g., software) stored on non-transitory media. Such non-transitory media may include memory devices such as those described herein, may include but not limited to random access memory (RAM) devices, read-only memory (ROM) devices, etc. Accordingly, other innovative aspects of the subject matter described in this disclosure can be implemented in one or more non-transitory media having software stored thereon.

In some examples, the software may include instructions for controlling a display driver for receiving image data from a central processing unit. The image data may include image data for display updates. The image data may, for example, include data for updates of a clock image. The software may include instructions for controlling a display driver for storing received image data in a display driver memory and for updating a display with stored image data at times indicated by a display driver clock. According to some implementations, the software may include instructions for controlling the display driver to control the display driver to perform the receiving, storing and updating while the central processing unit is switched off or operating in a sleep mode.

In some implementations, the software may include instructions for controlling the display driver for receiving compressed image data from the central processing unit and for storing the compressed image data in the display driver memory. The software may include instructions for controlling the display driver for retrieving a portion of the compressed image data at a time indicated by the display driver clock, for decompressing the portion of the compressed image data to produce a decompressed portion of image data and for updating the display with the decompressed portion of image data.

In some examples, the software may include instructions for controlling the display driver for converting the received image data from a first image data type to a second image data type suitable for controlling the display and for storing the second image data type in the display driver memory. In some implementations, the software may include instructions for controlling the display driver for receiving clock signals from the display driver clock, for selecting stored image data for updating the display based, at least in part, on the clock signals and for causing the selected image data to be provided by the memory to the display.

According to some implementations, the software may include instructions for controlling the display driver to generate image data for updates of the display. In some examples, the software may include instructions for controlling the display driver to generate the image data while a central processing unit of the display device is switched off or operating in a sleep mode. In some implementations, the image data may include data for updates of a clock image. In some examples, the software may include instructions for controlling the display driver for dithering image data.

Still other innovative aspects of the subject matter described in this disclosure can be implemented in a display device, which may include a display and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware be components, or combinations thereof. The control system may include a central processing unit and a display driver. In some examples, the display driver may include a display driver clock, a display driver memory and a graphics processing unit.

In some implementations, the display driver may be capable of generating, via the graphics processing unit, image data for updates of the display and of storing the image data in the display driver memory. The image data may, for example, include data for updates of a clock image. The display driver may be capable of updating the display with stored image data at times indicated by the display driver clock. In some examples, the display driver may be capable of performing the generating, storing and updating while the central processing unit is switched off or operating in a sleep mode.

According to some implementations, the display driver may include an image update engine capable of receiving clock signals from the display driver clock and of selecting stored image data for updating the display based, at least in part, on the clock signals. The image update engine may be capable of causing the selected image data to be provided by the memory to the display. In some examples, the graphics processing unit may be capable of dithering image data.

In some implementations, the display may include interferometric modulator (IMOD) pixels. However, other implementations may include a different type of display.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIGS. 5A-5E show examples of how an IMOD may be configured to produce different colors.

FIG. 6 is a block diagram that shows examples of display device components.

FIG. 7A is a flow diagram that shows examples of blocks that may be performed by a display device according to some implementations.

FIG. 7B is a flow diagram that shows additional examples of blocks that may be performed by a display device according to some implementations.

FIG. 8 is a flow diagram that shows additional examples of blocks that may be performed by a display device according to some implementations.

FIG. 9 is a block diagram that shows alternative examples of display device components.

FIG. 10 is a flow diagram that shows examples of blocks that may be performed by a display device such as that shown in FIG. 9.

FIG. 11 is a block diagram that shows alternative examples of display device components.

FIG. 12 is a flow diagram that shows examples of blocks that may be performed by a display device such as that shown in FIG. 11.

FIGS. 13A and 13B are system block diagrams illustrating a display device 40 that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various display device implementations disclosed herein include display drivers with enhanced capabilities. For example, in some implementations a display driver may be capable of updating a display while a central processing unit (CPU) is switched off or operating in a sleep mode. Some such display drivers may include a display driver clock and a display driver memory. The display driver may be capable of receiving image data from the CPU, including image data for display updates, and storing received image data in the display driver memory. The display driver may be capable of updating the display with stored image data at times indicated by the display driver clock. Some display drivers may include a graphics processing unit (GPU) capable of generating image data for updates of the display. In some such implementations, the graphics processing unit may be capable of dithering image data.

Particular implementations of the subject matter described in this disclosure can be implemented to realize one or more of the following potential advantages. Some such implementations may provide reduced power consumption, as compared to that of prior display devices. Including a display driver such as disclosed herein can reduce the power demands of a display device CPU. A display device having a low-power display, such as an IMOD-based display, already has potential advantages in terms of low power consumption by the display. Accordingly, a display device that includes both a display driver such as that disclosed herein and a low-power display, such as an IMOD-based display, may provide significant decreases in power consumption. Such advantages may apply even for “always on” use cases of a display device, such as an IMOD-based display of a smart watch or an IMOD-based secondary display, e.g., on the back of a smart phone.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

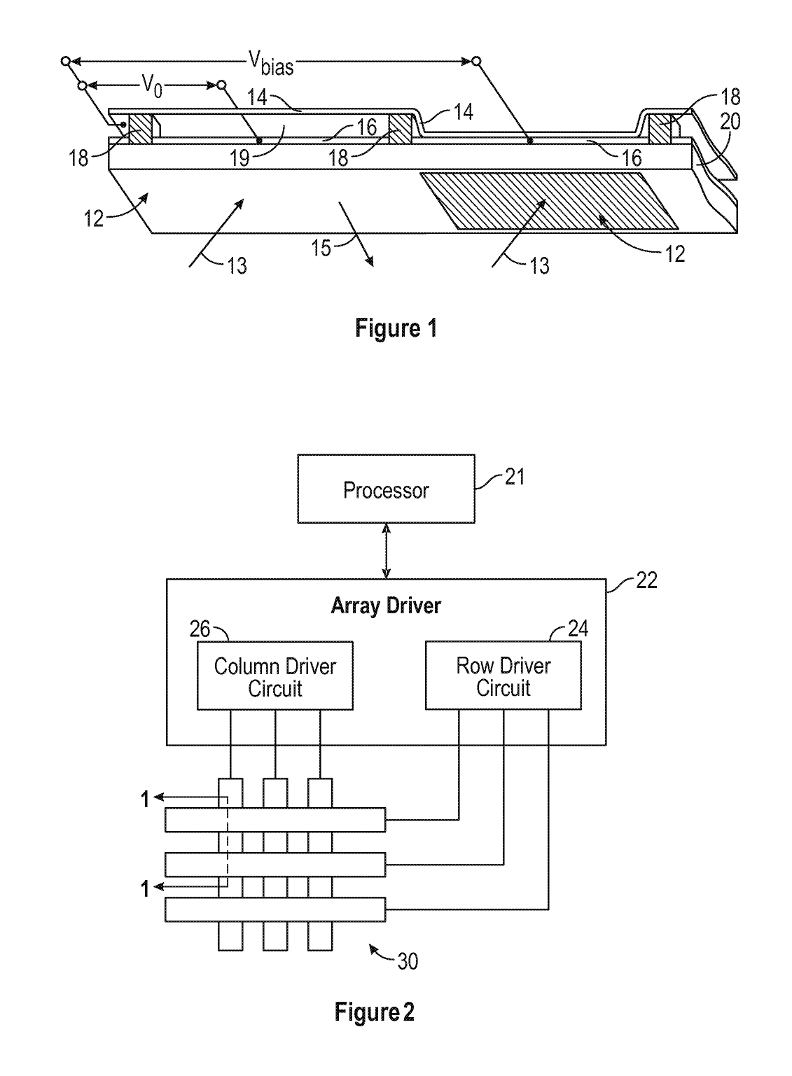

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

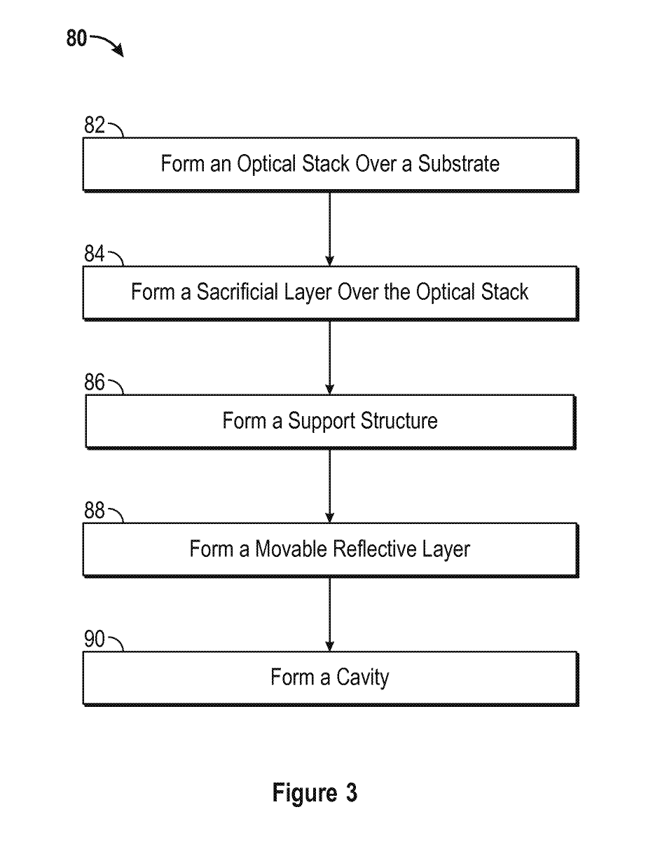

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

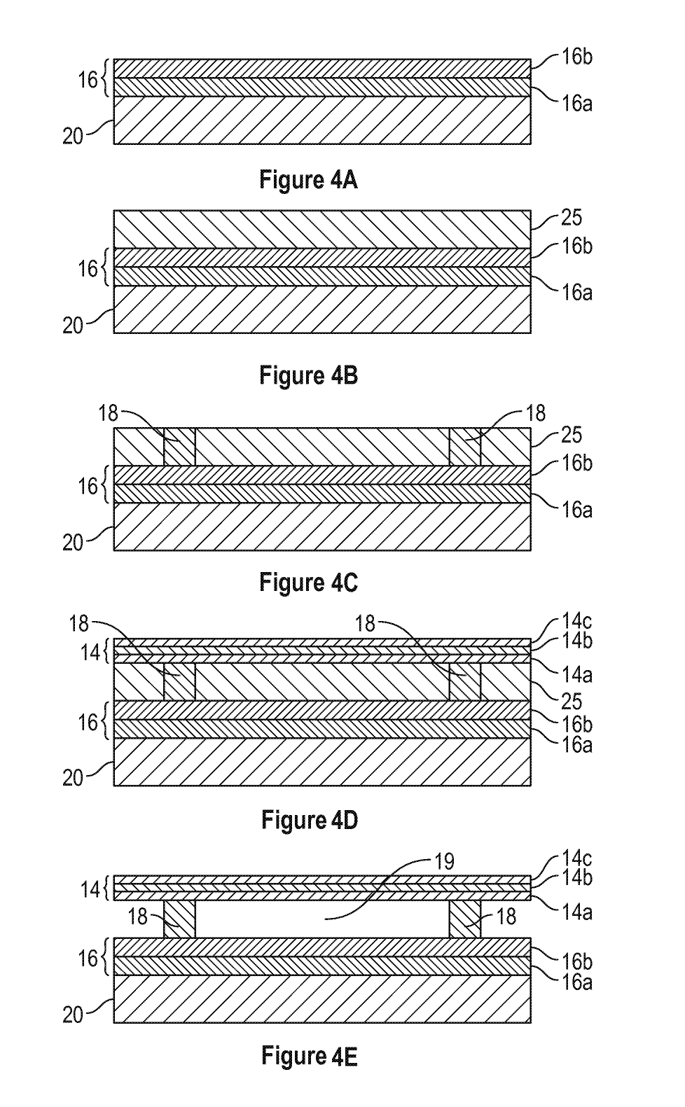

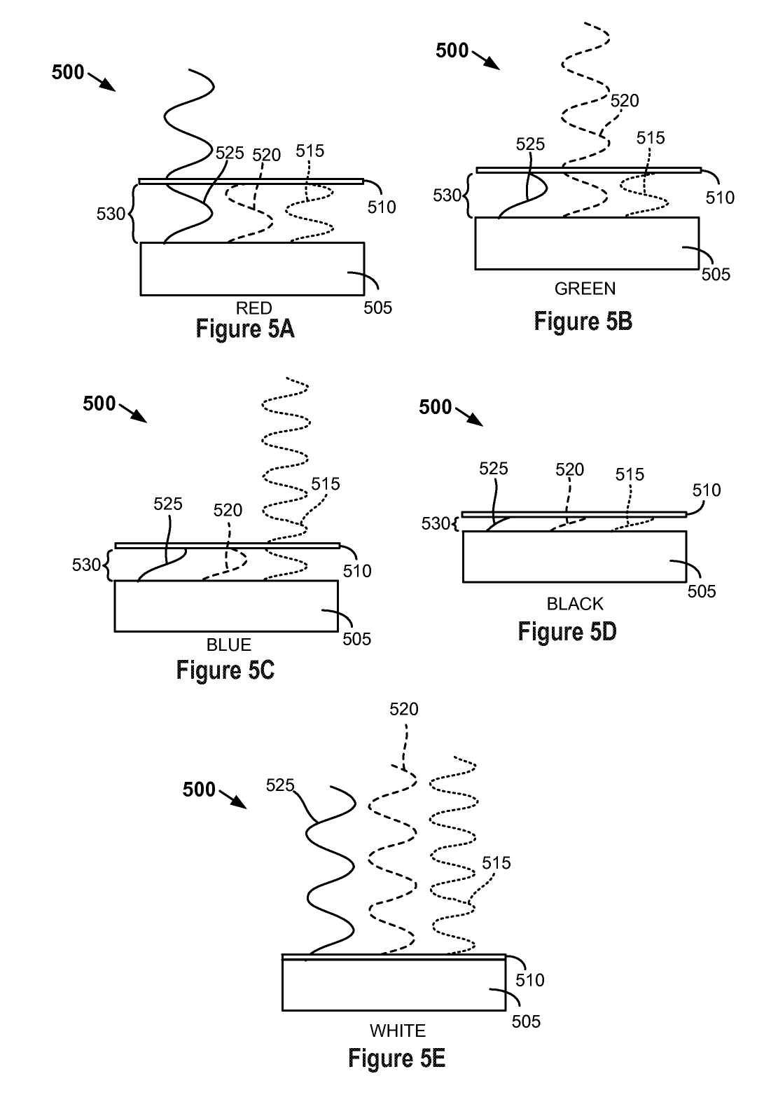

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 44. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

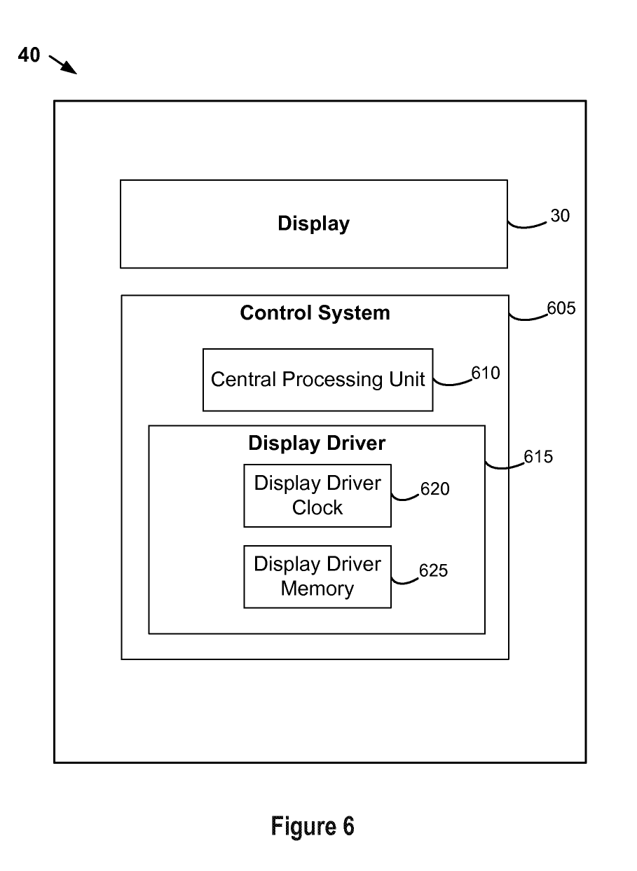

FIGS. 5A-5E show examples of how a single IMOD (IMOD) may be configured to produce different colors. Multistate IMODs (MS-IMODs) and analog IMODs (A-IMODs) are both considered to be examples of the broader class of IMODs.

In an MS-IMOD, a pixel's reflective color may be varied by changing the gap height between an absorber stack and a mirror stack. In FIGS. 5A-5E, the IMOD 500 includes the mirror stack 505 and the absorber stack 510. In this implementation, the absorber stack 510 is partially reflective and partially absorptive. Here, the mirror stack 505 includes at least one metallic reflective layer, which also may be referred to herein as a mirrored surface or a metal mirror.

In some implementations, the absorber layer may be formed of a partially absorptive and partially reflective layer. The absorber layer may be part of an absorber stack that includes other layers, such as one or more dielectric layers, an electrode layer, etc. According to some such implementations, the absorber stack may include a dielectric layer, a metal layer and a passivation layer. In some implementations, the dielectric layer may be formed of SiO₂, SiON, MgF₂, Al₂O₃ and/or other dielectric materials. In some implementations, the metal layer may be formed of Cr, W, Ni, V, Ti, Rh, Pt, Ge, Co and/or MoCr. In some implementations, the passivation layer may include Al₂O₃ or another dielectric material.

The mirror may, for example, be formed of one or more reflective metals such as Al, silver, etc. In some MS-IMODs, the mirror may be part of a mirror stack that includes other layers, such as one or more dielectric layers. Such dielectric layers may be formed of TiO₂, Si₃N₄, ZrO₂, Ta₂O₅, Sb₂O₃, HfO₂, Sc₂O₃, In₂O₃, Sn:In₂O₃, SiO₂, SiON, MgF₂, Al₂O₃, HfF₄, YbF₃, Na₃AlF₆ and/or other dielectric materials.

In FIGS. 5A-5E, the mirror stack 505 is shown at five positions relative to the absorber stack 510. However, an IMOD 500 may be movable between substantially more than 5 positions relative to the mirror stack 505. For example, in some A-IMOD implementations, the gap height 530 between the mirror stack 505 and the absorber stack 510 may be varied in a substantially continuous manner. In some such IMODs 500, the gap height 530 may be controlled with a high level of precision, e.g., with an error of 10 nanometers (nm) or less. Although the absorber stack 510 includes a single absorber layer in this example, alternative implementations of the absorber stack 510 may include multiple absorber layers. Moreover, in alternative implementations, the absorber stack 510 may not be partially reflective.

An incident wave having a wavelength λ will interfere with its own reflection from the mirror stack 505 to create a standing wave with local peaks and nulls. The first null is λ/2 from the mirror and subsequent nulls are located at λ/2 intervals. For that wavelength, a thin absorber layer placed at one of the null positions will absorb very little energy.

Referring first to FIG. 5A, when the gap height 530 is substantially equal to the half wavelength of a red wavelength of light 525 (also referred to herein as a red color), the absorber stack 510 is positioned at the null of the red standing wave interference pattern. The absorption of the red wavelength of light 525 is near zero because there is almost no red light at the absorber. At this configuration, constructive interference appears between red wavelengths of light reflected from the absorber stack 510 and red wavelengths of light reflected from the mirror stack 505. Therefore, light having a wavelength substantially corresponding to the red wavelength of light 525 is reflected efficiently. Light of other colors, including the blue wavelength of light 515 and the green wavelength of light 520, has a high intensity field at the absorber and is not reinforced by constructive interference. Instead, such light is substantially absorbed by the absorber stack 510.

FIG. 5B depicts the IMOD 500 in a configuration wherein the mirror stack 505 is moved closer to the absorber stack 510 (or vice versa). In this example, the gap height 530 is substantially equal to the half wavelength of the green wavelength of light 520. The absorber stack 510 is positioned at the null of the green standing wave interference pattern. The absorption of the green wavelength of light 520 is near zero because there is almost no green light at the absorber. At this configuration, constructive interference appears between green light reflected from the absorber stack 510 and green light reflected from the mirror stack 505. Light having a wavelength substantially corresponding to the green wavelength of light 520 is reflected efficiently. Light of other colors, including the red wavelength of light 525 and the blue wavelength of light 515, is substantially absorbed by the absorber stack 510.

In FIG. 5C, the mirror stack 505 is moved closer to the absorber stack 510 (or vice versa), so that the gap height 530 is substantially equal to the half wavelength of the blue wavelength of light 515. Light having a wavelength substantially corresponding to the blue wavelength of light 515 is reflected efficiently. Light of other colors, including the red wavelength of light 525 and the green wavelength of light 520, is substantially absorbed by the absorber stack 510.

In FIG. 5D, however, the IMOD 500 is in a configuration wherein the gap height 530 is substantially equal to ¼ of the wavelength of the average color in the visible range. In such arrangement, the absorber is located near the intensity peak of the interference standing wave; the strong absorption due to high field intensity together with destructive interference between the absorber stack 510 and the mirror stack 505 causes relatively little visible light to be reflected from the IMOD 500. This configuration may be referred to herein as a “black state.” In some such implementations, the gap height 530 may be made larger or smaller than shown in FIG. 5D, in order to reinforce other wavelengths that are outside the visible range. Accordingly, the configuration of the IMOD 500 shown in FIG. 5D provides merely one example of a black state configuration of the IMOD 500.

FIG. 5E depicts the IMOD 500 in a configuration wherein the absorber stack 510 is in close proximity to the mirror stack 505. In this example, the gap height 530 is negligible because the absorber stack 510 is substantially adjacent to the mirror stack 505. Light having a broad range of wavelengths is reflected efficiently from the mirror stack 505 without being absorbed to a significant degree by the absorber stack 510. This configuration may be referred to herein as a “white state.” However, in some implementations the absorber stack 510 and the mirror stack 505 may be separated to reduce stiction caused by charging via the strong electric field that may be produced when the two layers are brought close to one another. In some implementations, one or more dielectric layers with a total thickness of about λ/2 may be disposed on the surface of the absorber layer and/or the mirrored surface. As such, the white state may correspond to a configuration wherein the absorber layer is placed at the first null of the standing wave from the mirrored surface of the mirror stack 505.

Mobile display devices, such as smart watches, smartphones and tablets, are powered by batteries that are limited in size and capacity. As usage increases, such display devices become more converged and data-driven with new usage models, and the burden on the battery life increases. The display is generally a major part of this power consumption in a mobile display device. However, the power consumption of system resources, primarily the power consumption of the central processing unit (CPU) for providing high-resolution displays, also can reduce battery life significantly.

The system architectural solution for providing data to a mobile display is typically a continuous process. System hardware resources such as the application processor, the graphics processing unit (GPU), display controller and memory components are normally powered continuously to provide data in the system-to-display pipeline. In a smartphone, the system typically accounts for 45% to 50% of the total device energy consumption. Reducing this percentage of energy consumption could have a considerable effect on battery life.

Some implementations disclosed herein can potentially achieve reduced power consumption by adding functionality to a display driver to allow a CPU to remain inactive during predictable updates of a display, including but not limited to updates of a clock image. In some implementations, a CPU may provide image data (which may be compressed image data) for future updates of, e.g., a clock image to the display driver to be made while the CPU is switched off or operating in a “sleep” mode.

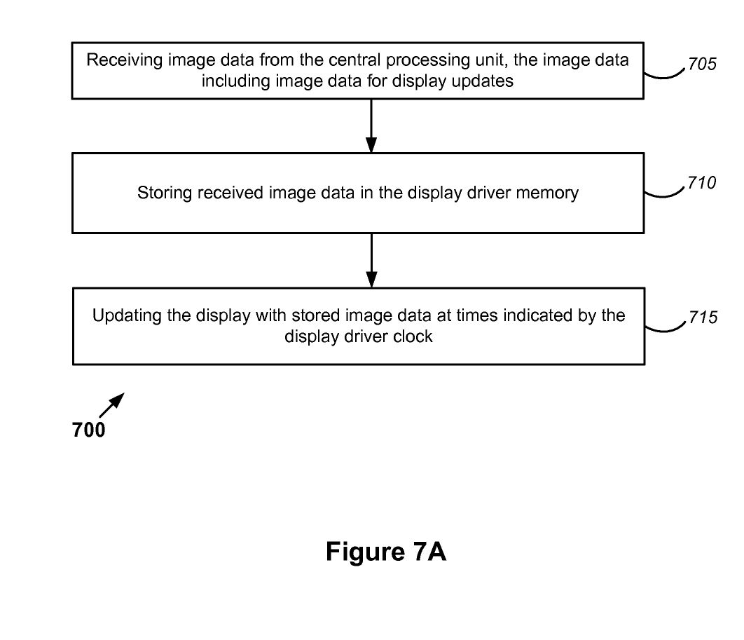

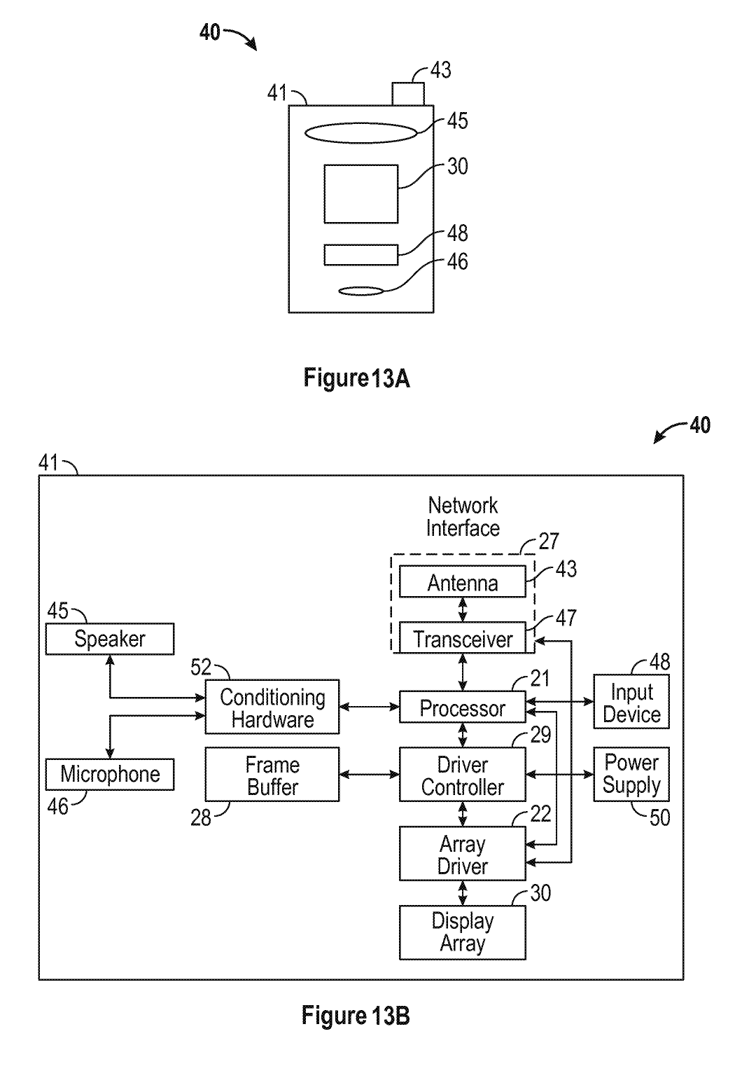

FIG. 6 is a block diagram that shows examples of display device components. In some implementations, the display device 40 may be a mobile device, such as a smart phone, a smart watch, etc. In some examples, the display device 40 may include features such as those described in FIGS. 13A and/or 13B, described below. In this example, the display device 40 includes a display 30 and a control system 605. The display 30 may be any suitable type of display. In some implementations, the display 30 has low power requirements. In some such implementations, the display 30 may include IMOD pixels.

The control system 605 may be capable of performing, at least in part, the methods disclosed herein. The control system 605 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

In this implementation, the control system 605 includes a central processing unit (CPU) 610 and a display driver 615. In this example, the display driver 615 includes a display driver clock 620 and a display driver memory 625. The display driver clock 620 may be implemented with application specific integrated circuit (ASIC) components, such as phase locked loops (PLLs). The display driver memory 625 may include one or more non-transitory media, such as one or more random access memory (RAM) devices, one or more read-only memory (ROM) devices, etc.

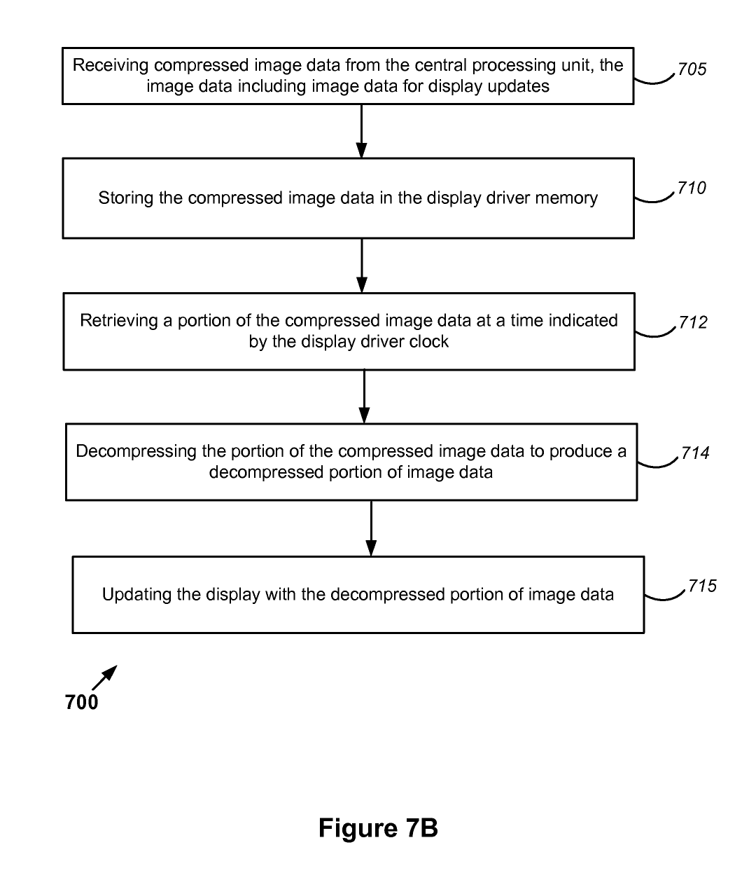

FIG. 7A is a flow diagram that shows examples of blocks that may be performed by a display device according to some implementations. The blocks of method 700 may, for example, be performed by the display driver 615 of FIG. 6. Accordingly, method 700 may be described with reference to the elements of FIG. 6. In some implementations, the blocks of method 700 may be performed, at least in part, according to software stored on one or more non-transitory media.

In this example, block 705 involves receiving image data from a central processing unit, such as the CPU 610 of FIG. 6. Here, the image data includes image data for display updates. The display updates may be predictable updates of a display, including but not limited to updates of a clock image. In this example, block 710 involves storing the received image data in a display driver memory, such as the display driver memory 625 of FIG. 6. Here, block 715 involves updating a display (such as the display 30 of FIG. 6) with stored image data. In this example, block 715 involves updating the display at times indicated by a display driver clock, such as the display driver clock 620 of FIG. 6. In other examples, block 715 may involve updating the display according to other types of input, such as input from a sensor. The display driver may be capable of performing the generating, storing and updating processes of blocks 705-715 while the CPU is switched off or operating in a sleep mode.

FIG. 7B is a flow diagram that shows additional examples of blocks that may be performed by a display device according to some implementations. The blocks of FIG. 7B may, for example, be performed by the display driver 615 of FIG. 6. Blocks 705, 710 and 715 are specific examples of the corresponding blocks of FIG. 7A.

According to this implementation, block 705 involves receiving compressed image data from the central processing unit. The image data includes image data for display updates. Here, block 710 involves storing the compressed image data in the display driver memory. Receiving and storing compressed image data may be advantageous. For example, as compared to uncompressed image data, more frames of compressed image data may be stored in a given size of display driver memory. By receiving and storing additional frames of image data for display updates, a CPU may potentially remain powered off or in “sleep” mode for a relatively longer period of time, resulting in potential energy savings and extended battery life.

In this example, block 712 involves retrieving a portion of the compressed image data at a time indicated by the display driver clock. For example, the retrieved portion may correspond with an update of a smart watch display that is updated once per minute. In other examples, block 712 may involve retrieving a portion of the compressed image data according to other types of input, such as input from a sensor. Accordingly, in this example the image data are decompressed before the image data are displayed. Accordingly, block 714 involves decompressing the portion of the compressed image data to produce a decompressed portion of image data. Here, block 715 involves updating the display with the decompressed portion of image data.

Some implementations may involve receiving image data for other types of predictable updates, such as image data for a screen rotation that is triggered by an inertial sensor. For example, in some implementations a CPU may provide image data for clock updates that correspond to more than one orientation of a display, such as a “landscape” orientation and a “portrait” orientation. Such image data may be selected and displayed according to input from an inertial sensor.

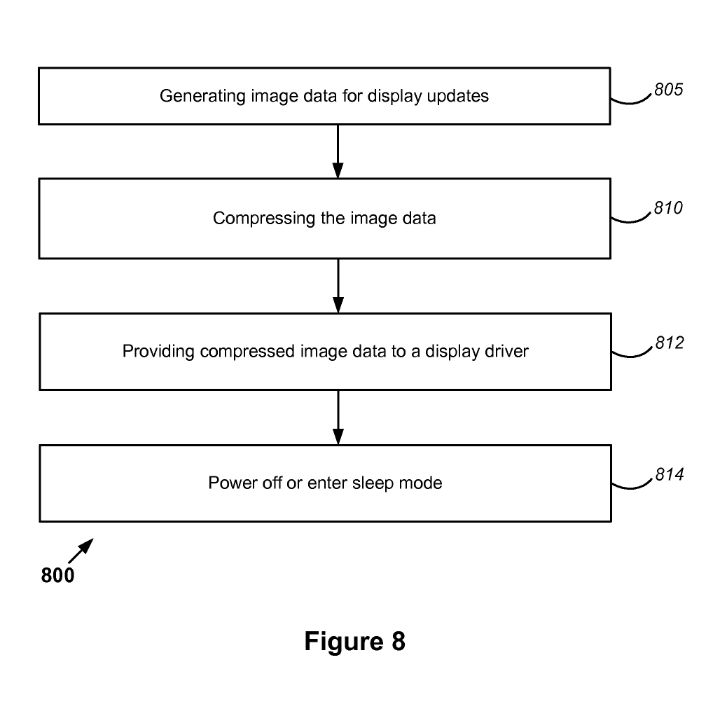

FIG. 8 is a flow diagram that shows additional examples of blocks that may be performed by a display device according to some implementations. The blocks of method 800 may, for example, be performed by the CPU 610 of FIG. 6.

In this example, block 805 involves generating image data for display updates. Here, block 810 involves compressing the image data and block 812 involves providing compressed image data to a display driver. Accordingly, block 812 may be thought of as the CPU-side counterpart of block 705 of FIG. 7B.

In this example, the CPU powers off or enters a sleep mode in block 814. In some implementations, the CPU may subsequently be switched on or awakened from sleep mode according to user input, according to sensor input (e.g., according to gyroscope and/or accelerometer input indicating that the display device is being moved), according to input from a control system clock and/or according to other input (such as a signal from the display driver indicating a need for image data for subsequent display updates). For example, the control system clock may re-start the CPU in time for the CPU to generate image data for subsequent display updates, compress the image data and provide compressed image data to the display driver when image data for subsequent display updates are needed.

In some implementations, a display driver may be capable of generating image data for updates of a corresponding display. The display driver may, for example, include a graphics processing unit. The display driver may or may not receive image data for display updates from the CPU, depending on the particular implementation.

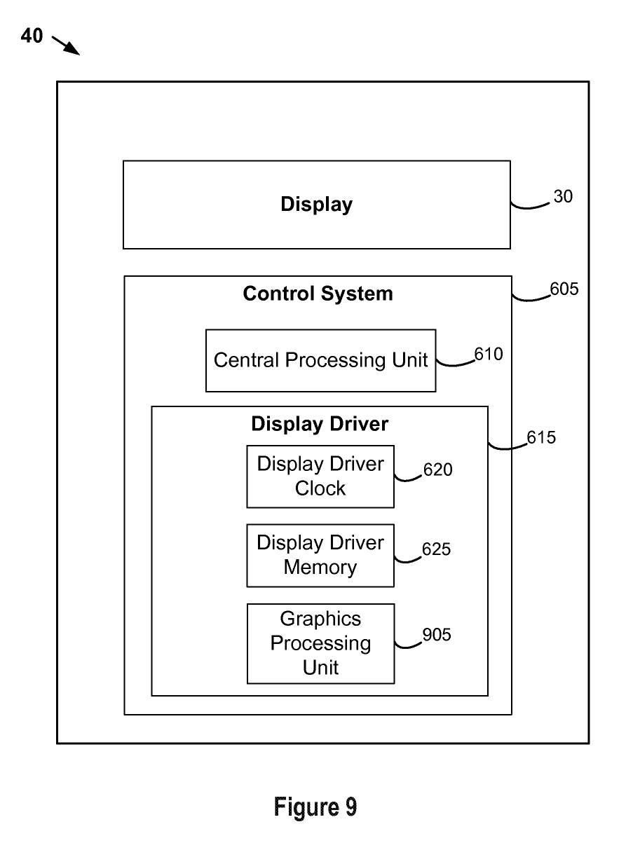

FIG. 9 is a block diagram that shows alternative examples of display device components. The elements shown in this implementation of the display device 40 may be substantially similar to those of FIG. 6. However, in the example of FIG. 9, the display driver 615 includes a graphics processing unit (GPU) 905. The GPU 905 may be any suitable type of electronic device that is capable of rapidly manipulating and altering memory to accelerate the creation of images in a frame buffer intended for output to a display. The frame buffer may, for example, be stored in a portion of the display driver memory 625 and may correspond with a memory buffer of the display driver memory 625. In some implementations, the GPU 905 may have a highly parallel structure that make the GPU 905 more effective than a general-purpose CPU for executing algorithms that involve processing of large blocks of data in parallel. Although not shown in FIG. 9, in some implementations the GPU 905 may have its own dedicated memory, such as a RAM. In some implementations, the GPU 905 may be capable of accessing memory that is also accessible by the CPU 610.

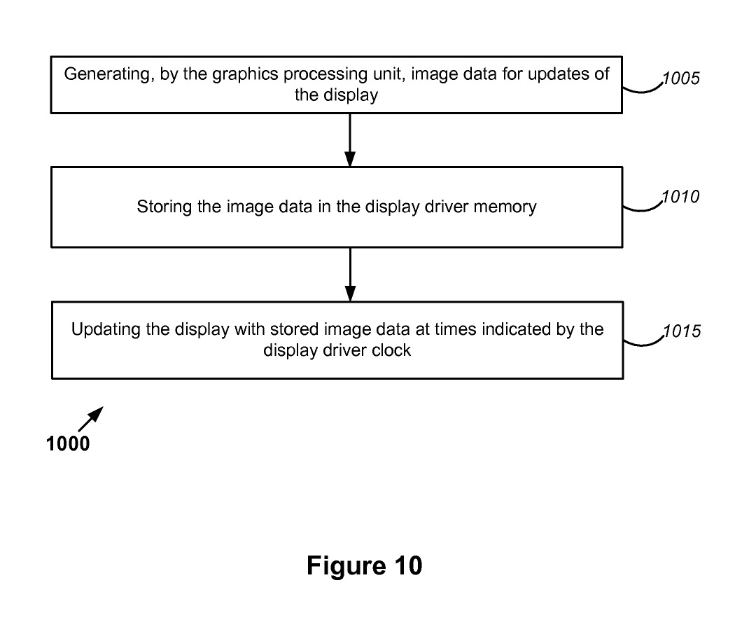

FIG. 10 is a flow diagram that shows examples of blocks that may be performed by a display device such as that shown in FIG. 9. The blocks of method 1000 may, for example, be performed by the display driver 615 of FIG. 9. In some implementations, the blocks of method 1000 may be performed, at least in part, according to software stored on one or more non-transitory media.

In this example, block 1005 involves generating, by the graphics processing unit, image data for updates of the display. The image data may, for example, include data for updates of a clock image. Here, block 1010 involves storing the image data in a display driver memory. In this implementation, block 1015 involves updating the display with stored image data at times indicated by a display driver clock. In alternative implementations, block 1015 may involve updating the display with stored image data at times indicated by a sensor. The display driver may be capable of performing the generating, storing and updating processes of blocks 1005-1015 while the CPU is switched off or operating in a sleep mode.

In some implementations, method 1000 may involve compressing the image data generated in block 1005 prior to storing the image data in block 1010. Similarly, method 1000 may involve retrieving a compression portion of the stored image data, decompressing the portion of image data and updating the display with the decompressed portion of image data. However, data compression may be relatively less important for implementations wherein a display driver is capable of generating image data for display updates, as compared to implementations wherein the display driver receives image data for display updates from the CPU.

In some implementations, the GPU 905 may be capable of dithering image data. Such functionality may be advantageous, for example, if pixels of the display 30 are capable of providing relatively few colors and/or greyscale states. The appearance of images displayed on some IMOD-based displays, for example, may benefit from dithering. For implementations in which the GPU 905 is capable of dithering image data, at least some dithering may be performed by the display driver 615. In some such implementations, all dithering may be performed by the display driver 615 instead of by the CPU 610. The dithering may be performed by the GPU 905 either during normal operation or while the CPU 610 is off or in a “sleep” mode. According to some implementations, the GPU 905 may be capable of rendering directly in the colors available in the display. For example, some IMOD-based displays may be capable of providing fewer colors than, e.g., liquid crystal displays. In some implementations, the GPU 905 may be capable of rendering in the colors available from a particular type of IMOD (e.g., an MS-IMOD), arrays of which are provided in the display, is capable of producing.

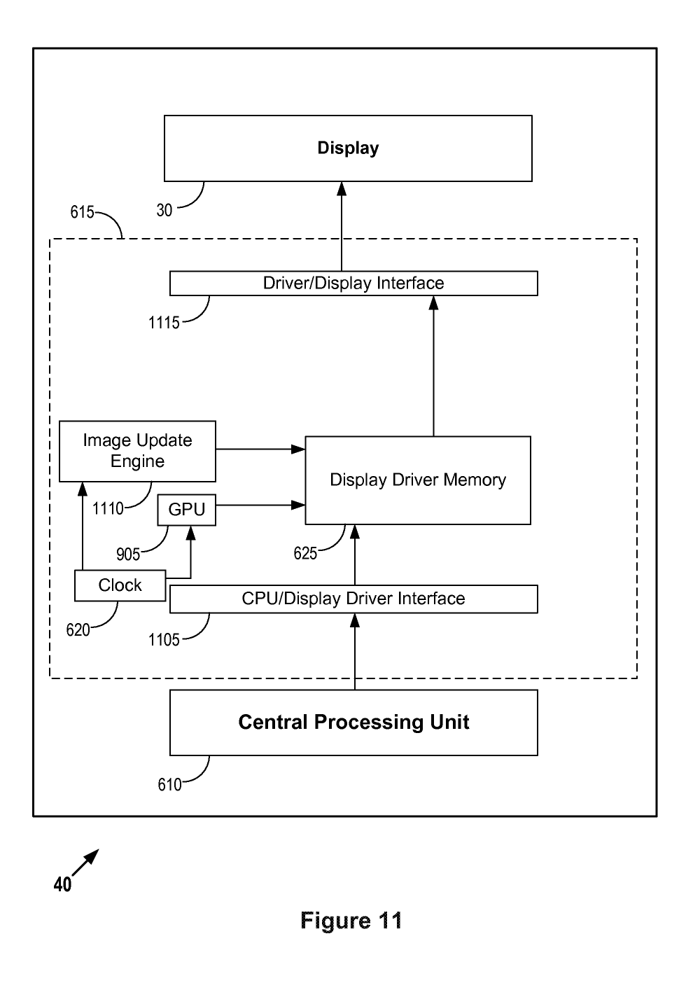

FIG. 11 is a block diagram that shows alternative examples of display device components. The display 30, CPU 610, display driver clock 620, display driver memory 625 and GPU 905 shown in this implementation of the display device 40 may be substantially similar to those of FIG. 9.

However, in the example of FIG. 11, the display driver 615 includes a CPU/display driver interface 1105, an image update engine 1110 and a driver/display interface 1115. The CPU/display driver interface 1105 may be capable of receiving a first type of image data from the CPU 610 and converting the first type of image data into a second type of image data suitable for controlling the display 30. For example, in some implementations, the second type of image data may be in a display-specific format such as 1080p, 720p, video graphics array (VGA) wide VGA (WVGA), half-size VGA (HVGA), etc. The second type of image data may be stored, at least temporarily, in the display driver memory 625. In some implementations, the CPU/display driver interface 1105 may be capable of providing functionality similar to that of the driver controller 29, which is shown in FIG. 13B and described below.

In this example, the image update engine 1110 is capable of causing stored image data for updates to be provided by the display driver memory 625 to the display 30 via the driver/display interface 1115.

In this implementation, the display driver's GPU 905 is capable of determining when an image for updating the display 30 should be generated, according to input from the display driver clock 620, and of generating the image. In some implementations, the GPU 905 may be capable of determining when an image for updating the display 30 should be generated according to other input, such as input from a sensor. In some implementations, the image may be stored in the display driver memory 625, whereas in other implementations the GPU 905 may provide the image to the display 30, via the driver/display interface 1115. In some implementations, the GPU 905 may be capable of dithering image data. The image update engine 1110 may be capable of determining when stored image data for updates should be provided by the display driver memory 625 to the display 30 according to input from the display driver clock 620, according to input from a sensor, etc.

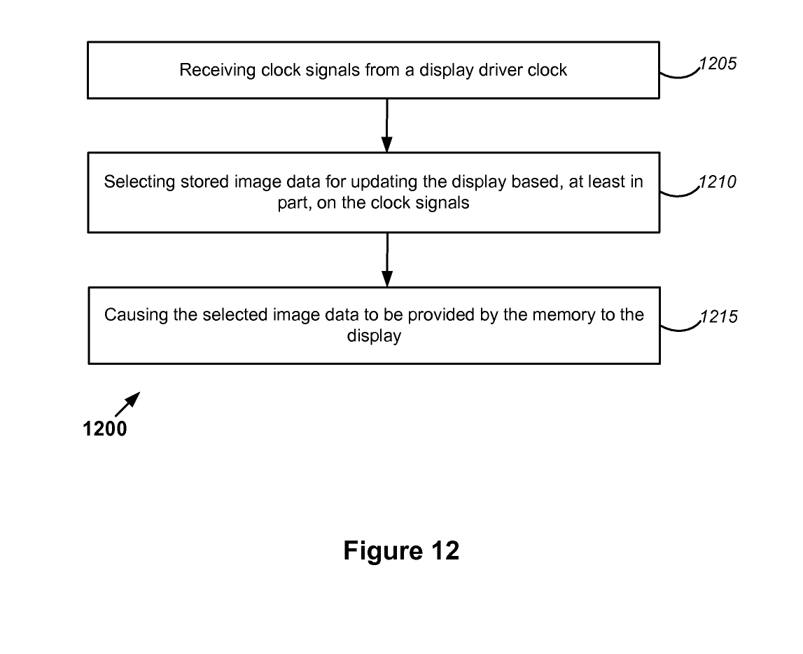

FIG. 12 is a flow diagram that shows examples of blocks that may be performed by a display device such as that shown in FIG. 11. The blocks of method 1200 may, for example, be performed by the image update engine 1110 of FIG. 11. In some implementations, the blocks of method 1200 may be performed, at least in part, according to software stored on one or more non-transitory media.

In this example, block 1205 involves receiving clock signals from a display driver clock, such as the display driver clock 620. Here, block 1210 involves selecting stored image data for updating the display based, at least in part, on the clock signals. In this example, block 1215 involves causing the selected image data to be provided by the memory to the display. In some implementations, the image update engine 1110 may be capable of determining when an image for updating the display 30 should be selected and provided to the display according to other input, such as input from a sensor.

FIGS. 13A and 13B are system block diagrams illustrating a display device 40 that includes a plurality of IMOD display elements. In some implementations, the IMOD display elements may include IMODs 500 as described elsewhere herein. The display device 40 can be, for example, a smart phone, a cellular or mobile telephone. However, the same components of the display device 40 or slight variations thereof are also illustrative of various types of display devices such as smart watches, televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display. The display may include IMODs such as those described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. In some implementations, the driver controller 29, the array driver 22 and the frame buffer 28 may provide display driver functionality such as that described above with reference to FIGS. 6-12. In some such implementations, the processor 21 and/or other components shown in FIG. 13B may provide CPU functionality such as that described above with reference to FIGS. 6-12. One or more elements in the display device 40, including elements not specifically depicted in FIG. 13B, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a−b, a−c, b−c, and a−b−c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device, comprising:
a display; and
a control system that includes:
a central processing unit; and
a display driver that includes a display driver clock and a display driver memory, the display driver being capable of:
receiving image data from the central processing unit, the image data including image data for display updates;
storing received image data in the display driver memory; and
updating the display with stored image data at times indicated by the display driver clock.

2. The display device of claim 1, wherein the central processing unit is capable of compressing image data and wherein the display driver is capable of:
receiving compressed image data from the central processing unit;
storing the compressed image data in the display driver memory;
retrieving a portion of the compressed image data at a time indicated by the display driver clock;
decompressing the portion of the compressed image data to produce a decompressed portion of image data; and
updating the display with the decompressed portion of image data.

3. The display device of claim 1, wherein the display driver is capable of performing the receiving, storing and updating while the central processing unit is switched off or operating in a sleep mode.

4. The display device of claim 1, wherein the display driver is capable of:
converting the received image data from a first image data type to a second image data type suitable for controlling the display; and
storing the second image data type in the display driver memory.

5. The display device of claim 1, wherein the image data includes data for updates of a clock image.

6. The display device of claim 1, wherein the display driver includes an image update engine capable of:
receiving clock signals from the display driver clock;
selecting stored image data for updating the display based, at least in part, on the clock signals; and
causing the selected image data to be provided by the display driver memory to the display.

7. The display device of claim 1, wherein the display driver includes a graphics processing unit capable of generating image data for updates of the display.

8. The display device of claim 1, wherein the control system further comprises:
a processor; and
an image source module capable of sending image source module image data to the processor, wherein the image source module includes at least one of a receiver, transceiver, and transmitter.

9. The display device of claim 1, further comprising:
an input device capable of receiving input data and of communicating the input data to the control system.

10. The display device of claim 1, wherein the display includes interferometric modulator (IMOD) pixels.

11. The display device of claim 1, wherein the control system includes one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

12. A non-transitory medium having software stored thereon, the software including instructions for controlling a display driver for:
receiving image data from a central processing unit, the image data including image data for display updates;
storing received image data in a display driver memory; and
updating a display with stored image data at times indicated by a display driver clock.

13. The non-transitory medium of claim 12, wherein the software includes instructions for controlling the display driver for:
receiving compressed image data from the central processing unit;
storing the compressed image data in the display driver memory;
retrieving a portion of the compressed image data at a time indicated by the display driver clock;
decompressing the portion of the compressed image data to produce a decompressed portion of image data; and
updating the display with the decompressed portion of image data.

14. The non-transitory medium of claim 12, wherein the software includes instructions for controlling the display driver to control the display driver to perform the receiving, storing and updating while the central processing unit is switched off or operating in a sleep mode.

15. The non-transitory medium of claim 12, wherein the software includes instructions for controlling the display driver for:
converting the received image data from a first image data type to a second image data type suitable for controlling the display; and
storing the second image data type in the display driver memory.

16. The non-transitory medium of claim 12, wherein the image data includes data for updates of a clock image.

17. The non-transitory medium of claim 12, wherein the software includes instructions for controlling the display driver for:
receiving clock signals from the display driver clock;
selecting stored image data for updating the display based, at least in part, on the clock signals; and
causing the selected image data to be provided by the memory to the display.

18. The non-transitory medium of claim 12, wherein the software includes instructions for controlling the display driver to generate image data for updates of the display.

19. The non-transitory medium of claim 18, wherein the software includes instructions for controlling the display driver to generate the image data while a central processing unit of the display device is switched off or operating in a sleep mode.

20. The non-transitory medium of claim 18, wherein the image data includes data for updates of a clock image.

21. The non-transitory medium of claim 18, wherein the software includes instructions for controlling the display driver for dithering image data.

22. A display device, comprising:
a display; and
a control system that includes:
a central processing unit; and
a display driver that includes a display driver clock, a display driver memory and a graphics processing unit, the display driver being capable of:
generating, by the graphics processing unit, image data for updates of the display;
storing the image data in the display driver memory; and
updating the display with stored image data at times indicated by the display driver clock.

23. The display device of claim 22, wherein the display driver is capable of performing the generating, storing and updating while the central processing unit is switched off or operating in a sleep mode.

24. The display device of claim 22, wherein the image data includes data for updates of a clock image.

25. The display device of claim 22, wherein the display driver includes an image update engine capable of:
receiving clock signals from the display driver clock;
selecting stored image data for updating the display based, at least in part, on the clock signals; and
causing the selected image data to be provided by the memory to the display.

26. The display device of claim 22, wherein the graphics processing unit is capable of dithering the image data.

27. The display device of claim 22, wherein the display includes interferometric modulator (IMOD) pixels.

28. The display device of claim 22, wherein the control system includes one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.
